(19) United States
(12) Patent Application Publication
(10) Pub. No.: US 2023/0244201 A1
(43) Pub. Date: Aug. 3, 2023

(54) TECHNOLOGY FOR PROCESSING AND EXCHANGING FIELD SIGNALS

(71) Applicant: Phoenix Contact GmbH & Co. KG, Blomberg (DE)

(72) Inventors: Felix Schulte, Geseke (DE); Benjamin Klimmek, Aerzen (DE)

(21) Appl. No.: 18/010,523

(22) PCT Filed: Jun. 16, 2021
(86) PCT No.: PCT/EP2021/066248

§ 371 Date: Dec. 15, 2022

(30) Foreign Application Priority Data
Jun. 17, 2020 (LU) LU101864

(51) Int. Cl. G05B 19/042; G05B 19/04; G05B 19/05

(52) U.S. Cl. CPC G05B 19/0423; G05B 19/041; G05B 19/05

(57) ABSTRACT

A field control system includes: a control component for exchanging electric signals with at least one field device; and a processing component for processing electric signals exchanged between the at least one field device and the control component. The processing component and the control component are electro-conductively and mechanically connected or connectable. In a connected state, the electric signals are exchangeable between the at least one field device and a control system connected to the field control system by the processing component and the control component.

### CROSS-REFERENCE TO PRIOR APPLICATIONS

This application is a U.S. National Phase application under 35 U.S.C. § 371 of International Application No. PCT/EP2021/066248, filed on Jun. 16, 2021, and claims benefit to Luxembourg Patent Application No. LU 101864, filed on Jun. 17, 2020. The International Application was published in German on Dec. 23, 2021 as WO/2021/255099 under PCT Article 21(2).

### FIELD

The invention relates to a technique for processing and exchanging field signals. Without being limited thereto, a field control system for processing and exchanging electric signals, a processing component for processing electric signals exchanged between at least one field device and a control component, and a control component for exchanging the electric signals are provided.

### BACKGROUND

The process industry uses controlling and regulating techniques in order to reduce the time—and thus the costs of implementation—for modernization measures of existing plants or for faster construction of new plants. In this context, plants for processing oil and gas are merely illustrative examples.

These fields of application require exchanging and processing signals between at least one field device and a controller quickly and easily. The field devices include, for example, sensors and actuators. The sensors transmit input signals, which represent the state of process variables, to the controller. The actuators receive output signals from the controller and perform measures for influencing the process variables.

The document U.S. Pat. No. 9,971,727 B2 discloses a universal interposer system for processing input and output signals of a field device between the field device and a process controller. The interconnection system thereby comprises a base unit and a signal processing unit. The signal processing unit is attached to the base unit and processes the signals exchanged between the field device and the process controller.

However, this interposer system requires a technique, which is adapted to the interposer system, for the signal processing, and a technique, which is adapted to the interconnection system, for the process control. An exchange of the attachable signal processing unit can further require an adaptation of the process control.

The signal processing has to be connected, for example, to input and/or output channels (in short: I/O ports) of the process controller, which match the function of the signal processing. For this purpose, “universal I/O cards” (in short: UIO cards), which in each case match the function of the signal processing, are used in the prior art. These UIO cards, however, require additional installation space, are a possible cause for setup errors and functional failures of the plant, and increase the setup time and the setup costs.

### SUMMARY

In an embodiment, the present invention provides a field control system, comprising: a control component configured to exchange electric signals with at least one field device; and a processing component configured to process electric signals exchanged between the at least one field device and the control component, wherein the processing component and the control component are electro-conductively and mechanically connected or connectable, and wherein, in a connected state, the electric signals are exchangeable between the at least one field device and a control system connected to the field control system by the processing component and the control component.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic block view of a first exemplary embodiment of a field control system for processing exchanged signals with a processing component and a control component;

FIG. 2 shows a schematic block view of a second exemplary embodiment of the field control system, which can be realized as further development of the first exemplary embodiment with several slots;

FIG. 3 shows a schematic block view of a third exemplary embodiment of the field control system, which can be realized as further development of the first exemplary embodiment with a supply component;

FIG. 4 shows a schematic sectional view of a fourth exemplary embodiment of the field control system;

FIG. 5 shows a schematic block view of a fifth exemplary embodiment of the field control system, which can be realized as further development of the third exemplary embodiment with control components arranged outside of the field control system; and

FIG. 6 shows a schematic block view of several field control system, which are electro-conductively connected to one another, according to one of the exemplary embodiments.

### DETAILED DESCRIPTION

In an embodiment, the present invention provides a more compact technique for processing and exchanging field signals, which simplifies installation and retrofitting. An embodiment provides for a change of the signal processing, without changes to the hardware of the process controller being necessary.

A first aspect relates to a field control system, which comprises a control component, which is configured to exchange electric signals with at least one field device. The field control system further comprises a processing component, which is configured to process electric signals exchanged between the at least one field device and the control component. Thereby, the processing component and the control component are mechanically connected or connectable and are electro-conductively connected or connectable. In the connected state, the electric signals can be exchanged (i.e., are exchangeable) between the at least one field device and a control system connected to the field control system by means of the processing component and the control component.

Due to the electro-conductive connection between the control component and the processing component, exemplary embodiments can forgo UIO cards. These or further exemplary embodiments can comprise a control component, which is configured to provide input and/or output channels (in short: I/O ports), which are adapted or can be adapted to the function of the processing component, via the electrical connection to the processing component, for example a bus coupler.

The control component can be configured to provide I/O ports for exchanging the electric signals via the electro-conductive connection, as a function of the function of the processing component. The control component can preferably be configured to adapt a communication direction (for example for input signals or for output signals) and/or a signal form (for example for analog signals or for coded or logic or digital signals) for exchanging the electric signals via the electro-conductive connection to the processing component, to the function of the processing component.

In that the control component is configured to provide at least one adaptable I/O port and/or at least one adaptable communication direction and/or at least one adaptable signal form for the electro-conductive connection to the processing component, exemplary embodiments provide for a more compact field control system for processing and exchanging the electric signals. The use of UIO cards can be forgone when constructing or retrofitting such a field control system. These or further exemplary embodiments can provide for a change of the signal processing, without changes to the hardware of the control component being necessary.

The field control system can be embodied, for example, by a housing, which is configured for receiving the processing component and/or the control component. The housing can further be configured for arrangement within an assembly carrier, for example of a rack or of a control cabinet. The housing can further be configured for arrangement outside of an assembly carrier, for example of a rack or of a control cabinet.

The electric signals can be, for example, digital and/or analog electric signals. The electric signals can further be, for example, input and/or output signals. The electric signals can further be, for example, electric logic signals.

The processing component can also be referred to as signal processing unit. In the alternative or in addition, the control component can be configured to perform a process control. The control component can be configured to detect and/or to process the electric signals from the at least one field device (for example a sensor). The detected and/or processed signals can be input signals, which indicate the state of process variables. In the alternative or in addition, the control component can be configured to send the electric signals to the at least one field device (for example an actuator). The sent signals can be output signals, which control or regulate the process variables. The actuators can be configured to receive the output signals from the control component and to perform measures for influencing the process variables.

The electric signals can comprise one or several values (for example an actual value in the input signal or a setpoint value in the output signal) and/or can be used for transmitting one or several values. The values can relate to process variables.

The at least one field device can comprise an actuator and/or a sensor. The actuator can comprise, for example, a control element or a valve The sensor can comprise, for example, a measuring transducer. The control component can monitor or control (preferably regulate) a process, in particular an automation process or a technical plant, by means of the exchanged electric signals. In the alternative or in addition, the at least one field device can be a part of a (for example, production or process) plant and/or can be a technical facility in the field of automation technology, for example, used or usable in an automation process.

The at least one field device can further be arranged spaced apart from the field control system. The at least one field device can, for example, be remote-controlled by means of the electric signals from the field control system.

The at least one field device can optionally be electro-conductively connected to the processing component by means of a field bus. In the alternative, a respective channel of the processing component can be electro-conductively connected to a respective one of the at least one field device. The processing component can comprise an isolation amplifier or a relay, for example for each channel.

The processing component can send the electric signals to the at least one field device and/or can receive them from the at least one field device. In the alternative or in addition, the control component can send the electric signals to the control system and/or receive them from the control system.

The electric signals can comprise status information or control signals. The control component can be configured to control, preferably to regulate, the at least one field device. The control component can be configured to send control signals to the at least one field device by means of the electric signals and/or to receive information from the field device by means of the electric signals. The control component can further be configured to be controlled by means of signals received from the control system and/or to send information from the at least one field device to the control system by means of the electric signals.

The control component can further be configured to control (preferably to regulate) the at least one field device (for example in accordance with the control system). In the alternative or in addition, the control component can be configured to control (preferably to regulate) the at least one field device independently of the control system, for example for a first period of time.

The control system can further be configured for controlling and/or regulating the processing component and/or the at least one field device.

The control component and the control system can control the at least one field device hierarchically. The control component can be formed, for example, to control the at least one field device (for example the process variables thereof) in real time and/or to control it autonomously or independently of the control system over a first period of time. The control system can be configured to control the control component, for example to control process parameters of the control component. The control system can specify the process parameters for a second period of time, which is larger than the first period of time.

The connected state can refer to the processing component and the control component. The processing component and the control component can be connected by means of a common housing and/or irreversibly mechanically.

The electro-conductive connection and/or the mechanical connection can be releasable irreversibly or in a non-destruction-free manner. In the alternative or in addition, the processing component and the control component can be connected to one another electro-conductively and mechanically in a common housing of the field control system.

The control component can exchange the electric signals between the at least one field device and the control system, in that the control component sends individual or aggregated or all signals from the at least one field device to the control system. In the alternative or in addition, the control component can exchange the electric signals between the at least one field device and the control system, in that the control component receives process parameters or setpoint values for regulating variables from the control system, and controls or regulates the at least one field device in accordance with the received process parameters or setpoint values. The regulation can comprise a detection of actual values relating to the regulating variables in the electric signals (which are preferably processed by the processing component) from the at least one field device and/or a sending of control values or control instructions relating to the regulating variables in the electric signals (which are to preferably be processed by the processing component) to the at least one field device. The control values or control instructions can be a function of a deviation, preferably a difference, between the setpoint values and the actual values.

In the connected state, the processing component and the control component can further be configured to transmit status information of the processing component to the control component. The status information can comprise, for example, information about a functional range (in short: a function), an operating state, in particular an error state, and/or identifiers of the control component and/or of the processing component.

The status information of the processing component can comprise or can specify (for example by means of a function detection of the function) a functional range (in short: a function) of the processing of the electric signals performed by the processing component. In the alternative or in addition, the status information can specify or determine a communication protocol and/or an interface and/or a signal form for exchanging the electric signals between the processing component and the control component.

The processing component and the control component can in each case comprise a control component connection or a processing component connection, respectively. The control component connection and the processing component connection can be configured to connect the processing component and the control component to one another electro-conductively, preferably also mechanically, in the connected state. In the alternative or in addition, the control component connection and the processing component connection can in each case comprise a plug connector half. Each of the plug connector halves can thereby have a plug, a contact strip, or one or several plug contacts. The plug connector half can be configured for the mechanical connection and for the electro-conductive connection.

The field control system can further comprise a housing for mechanically connecting the control component and the processing component. The housing, for example the control component bay, and the processing component bay of the housing, can secure or arrange the processing component and the control component relative to one another. The mechanical connection can be realized, for example, by means of a control component bay in the housing, which is configured to receive the control component, and by means of a processing component bay in the housing, which is configured to receive the processing component.

In the alternative or in addition, the field control system can comprise a field control system interface, for example a bus coupler. The field control system interface can be configured to electro-conductively connect the control component and the processing component to one another in the connected state (for example in the state of being connected directly or in the state of being received in the respective bay).

The field control system interface can be integrated into the housing, A socket in the processing component bay can be electro-conductively connected, for example, to a socket in the control component bay. In the received state of the control component, the socket in the processing component bay can be electro-conductively connected to the control component connection. In the received state of the control component, the socket in the control component bay can be electro-conductively connected to the processing component connection. The respective socket of the control component bay and/or of the processing component bay can further be configured for the electro-conductive and mechanical connection of the control component or of the processing component, respectively.

The field control system can comprise one or several control components bays and/or one or several processing component bays. The field control system can be formed modularly with the control component received in the control component bay and the processing component received in the processing component bay.

The field control system interface can comprise, for example, an electro-conductive signal bus (for example a serial data bus), which electro-conductively connects the processing component to the control component. The field control system interface can optionally be configured to exchange the electric signals between the one or the several processing components and the one or the several control components.

The field control system can further comprise a supply component. The supply component can be configured to supply the field control system, the control component, and/or the processing component with electric energy. The supply component can comprise at least one supply connection for absorbing the electric energy. The processing component can be configured to guide the absorbed electric energy to a slot of the processing component and/or to the control component.

The supply connection can be configured for connecting an electric energy source. The electric energy source can comprise a supply circuit, a battery and/or a voltage source/current source. The supply component can be configured to convert, rectify and/or to smooth a voltage.

The supply component can have two or more supply connections. The supply component can be configured to optionally absorb the electric energy from a first supply connection of the two or more supply connections and from a second supply connection of the two or more supply connections. The optional absorption of the electric energy from the two or more supply connections can ensure a redundant supply of the field control system, preferably of the control component and/or of the processing component, with the electric energy.

The supply component can further be configured to transmit status information from the supply component to the field control system, preferably to the control component. The control component can be configured to actuate the supply component as a function of the status information.

The status information of the supply component can specify a functional range (in short: function) of the supply component. In the alternative or in addition, the status information of the supply component can comprise a status of the at least one supply connection or of each of the supply connections. The status information can specify, for example, which supply connection is used to absorb the electric energy and/or which voltage is applied at the or each supply connection and/or which current is absorbed at the or each supply connection.

In the alternative or in addition, the status information can comprise an operating state of the supply component and/or an error state of the supply component and/or an identifier of the supply component. The status information can further comprise additional information of the supply component, such as, for example, information about the output electric energy, about configurations and/or about the installed hardware of the supply component.

A second aspect relates to a processing component for forming a field control system, preferably according to the first aspect, and/or for processing electric signals exchanged between the at least one field device and the control component. The processing component comprises at least one field device connection, which is configured for the electro-conductive connection to the at least one field device outside of the field control system. The processing component further comprises a control component connection, which is configured for the electro-conductive connection to the control component within the field control system. The processing component is configured to process the electric signals exchanged between the at least one field device connection and the control component connection.

The processing component can further comprise each feature, which is disclosed in the context of the first aspect or of the field control system, or a corresponding feature. The control component connection can comprise, for example, a plug connector half, preferably a plug contact, or a contact strip.

The processing component can optionally comprise an external control component connection, which is configured for the electro-conductive connection to an external control module, for example a programmable logic controller (PLC) and/or a control system, preferably a process control system (PCS, technically also: “Distributed Control System” or DCS) outside of the field control system. The processing component can be configured for transmitting the electric signals between the at least one field device connection and the control component connection and/or the external control component connection. The external control module can provide or enable a control function, which is redundant with respect to the control component.

The formation of the field control system can comprise the electro-conductive and mechanical connection of the processing component to the control component. The processing component can be, or can be capable of being, electro-conductively and mechanically connected directly to the control component. In the alternative or in addition, the processing component can be received or can be capable of being received with the control component in a housing.

The control component connection can further be configured for the mechanical connection to the control component within the field control system. In the alternative or in addition, the processing component can have a housing, which is formed (or configured) to be mechanically connected to the control component and/or to receive the control component.

The processing component can further comprise at least one slot. The or each slot can be configured to electro-conductively and mechanically connect a signal processing module to the processing component. The or each slot can comprise, for example, a plug connector half, for example a contact strip socket.

The slot can comprise a field-side portion, in which the processing component is electro-conductively connected to the field device connection. The slot can comprise a control-side portion, in which the processing component is electro-conductively connected to the control component connection.

The processing component can optionally comprise at least one signal processing module, which is inserted or can be inserted into the at least one slot. The or each signal processing module can be inserted or can be capable of being inserted releasably into the slot. The or each signal processing module can comprise, for example, a plug connector half, preferably a contact strip plug, for the electro-conductive connection to the slot.

The plug connector half on the signal processing module can comprise a field-side portion, which, in the inserted state, is electro-conductively connected to the field-side portion of the slot. The plug connector half on the signal processing module can comprise a control-side portion, which, in the inserted state, is electro-conductively connected to the control-side portion of the slot.

The or each signal processing module can be configured to process the electric signals exchanged between the at least one field device connection and the control component connection and/or the external control component connection. Each slot can be assigned, for example, to a field device or a channel for exchanging the electric signals with the at least one field device. The or each signal processing module can process the electric signals exchanged via the assigned channel or with the assigned field device.

The processing component can further be configured to provide status information of the processing component, preferably status information of the at least one signal processing module, on the control component connection and/or on the externa control component connection.

The or each signal processing module can transmit its functional range (in short: function) of the processing of the exchanged signals to the control component as status information of the processing component.

The processing of the electric signals, i.e. the functional range, can comprise, for example, a converting (for example a sampling, digitizing, or amplification) and/or evaluation (for example a discretizing) of the electric signals. In the alternative or in addition, the or each signal processing module input and/or signal output for the at least one or assigned field device according to the function can be a signal. The function can be configured or can be capable of being configured, for example, by the control component. The or each signal processing module can further transmit the electric signals between the at least one field device and the control component.

The processing component can be configured to send the status information of the signal processing module, which specifies the functional range. The status information specifying the functional range can be sent (preferably to the control component) in response to the electro-conductive connection (for example of the signal processing module to a corresponding slot) and/or in response to the electro-conductive connection of the processing component to the control component and/or in response to a request of the functional range revived (for example wirelessly or via the slot) from the control component.

In the alternative or in addition, the processing component (for example the or each signal processing module) can comprise a circuit for the galvanic separation (also: isolating circuit or junction plane) of the electric signals exchanged between field device and the control component.

The signal processing module can comprise a digital input (DI), a digital output (DO), an analog input (AI) and/or an analog output (AO) according to the functional range, preferably on the field-side portion of the plug connector half on the signal processing module or of the slot, respectively. The DI can be an input for detecting and/or processing digital electric signals. The DO can be an output for processing and/or outputting digital electric signals. The AI can be an input for detecting and/or processing analog electric signals. The AO can be an output for processing and/or outputting analog electric signals.

The functional range of the signal processing module can comprise at least one of the following signal processing. A first signal processing comprises a relocation of an electric signal detected by the field-side portion of the slot to a DI of the control component, which is electro-conductively connected by means of the control-side portion of the slot. A second signal processes comprises a relocation of an electric signal detected by the control-side portion of the slot by a DO of the control component to the field-side portion of the slot. A third signal processing comprises a relocation of an electric signal detected by the field-side portion of the slot to an AI of the control component, which is electro-conductively connected by means of the control-side portion of the slot. A fourth signal processing comprises a relocation of an electric signal detected by the control-side portion of the slot by an AO of the control component to the field-side portion of the slot.

A fifth signal processing comprises a provision of a digital DI to the at least one field device on the field-side portion of the slot, wherein the DI is configured to detect the electric signals of the at least one field device. A sixth signal processing comprises a provision of a DO to the at least one field device on the field-side portion of the slot, wherein the DO is configured to output the electric signals to the at least one field device. A seventh signal processing comprises a provision of an AI on the field-side portion of the slot to the at least one field device, wherein the AI is configured to detect the electric signals of the at least one field device. An eighth signal processing comprises a provision of an AO on the field-side portion of the slot to the at least one field device, wherein the AO is configured to output the electric signals to the at least one field device.

The functional range can comprise at least two alternative states of the signal processing of the signal processing module. In the alternative or in addition, the processing component (for example the or each signal processing module) can be configured to receive control signals from the control component via the control component connection. The control signals can predetermine a state of the alternative states. The processing component can further be configured to assume the predetermined state of the signal processing.

The or each signal processing module can comprise a transducer for the electric signals. Analog or digital electric signals can be converted, for example. The transducer can be an analog-to-digital transducer or a digital-to-analog transducer.

A third aspect relates to a control component for forming a field control system according to the first aspect and/or for the electro-conductive and mechanical connection to a processing component according to the second aspect. The control component comprises a control module, preferably a programmable logic controller (PLC), which is configured to exchange the electric signals with the at least one field device. The control component further comprises at least one configurable connecting module and a processing component connection, which is configured to electro-conductively connect the control module to the processing component for exchanging the electric signals via the configurable connecting module. The control component further comprises at least one system connection, via which the control module is or can be electro-conductively connected to a control system. In the connected state, the electric signals can be exchanged with the control system.

The control module can comprise a programmable logic controller (PLC) and/or a control system, preferably a process control system (PCS, technically also: “Distributed Control System” or DCS).

The control component can be or is capable of being mechanically connected to the processing component connection. In the alternative or in addition, the control component can have a housing, which is connected or can be connected to the processing component and/or in which the processing component is received or can be received.

The control module can further be configured to control the at least one field device, preferably in accordance with the control system.

The control component can be or can be capable of being electro-conductively and mechanically connected to the processing component by means of the processing component connection, preferably a plug connector half. In the connected state, the electric signals can be capable of being exchanged between the at least one field device and the control system by means of the processing component and the control component.

The processing component connection can be configured for the electro-conductive connection to the processing component via the field control system interface and/or directly to the control component connection of the processing component.

In that the control component exchanges the electric signals with the at least one field device via the processing component, the processing component can process the electric signals exchanged between the at least one field device and the control component, for example convert the signal form thereof, preferably for controlling the field devices and/or for passing on the processed signals to the control system.

The at least one configurable connecting module can comprise at least one connecting line or a connecting contact of the processing component connection. The or each configurable connecting module can provide an input and/or output channel (in short: I/O port) of the control component on the processing component connection. The input and/or output channel (I/O port) provided by the configurable connecting module can also be referred to as configurable input and/or output channel (configurable I/O port).

The at least one configurable connecting module can be configured to optionally detect or to output (for example to either detect or to output the electric signals) the electric signals, in accordance with a configuration of the (or of the respective) configurable connecting module at the at least one connecting line or the at least one connecting contact of the processing component connection. In the alternative or in addition, the at least one configurable connecting module can be configured to optionally process analog or digital electric signals (for example either analog or digital electric signals) in accordance with the configuration of the (or of the respective) configurable connecting module on the at least one connecting line or the at least one connecting contact of the processing component connection.

The connecting line can be a connecting line between the configurable connecting module and the processing component connection, for example a printed circuit board track. In the alternative or in addition, the connecting contact can be a contact in the processing component connection.

In other words, the configurable connecting module can be configured to optionally operate the at least one connecting line of the processing component connection as signal input or as signal output and/or to optionally process analog or digital signals on the at least one connecting line of the processing component connection. The configuration of the configurable connecting module (for example a mode of the configurable connecting module) can determine whether the electric signals are either detected or output and/or whether the electric signals are analog or digital.

The control module can further be configured to control (for example to determine) the configuration (for example the mode) of the connecting module.

The control module can further be configured to change the configuration of the configurable connecting module in response to the detected status information of the processing component. The configuration of the configurable connecting module can be adapted, for example, to the function of the signal processing module, which is connected to the control module via the configurable connecting module.

Based on the status information, which specifies the functional range of the processing of the electric signals exchanged between the at least one field device and the control system, the control component and/or the control system can determine (for example in that the control component sends the status information to the control system), whether a (for example functionally) correct or sufficient signal processing module is present and/or whether the signal processing module is inserted into the correct slot.

In response to a change or expansion of a process controlled by the control component and/or the control system (which is implemented, for example, by means of the at least one field device), it can be determined, for example, whether this process can be performed according to the functional range by means of the functions of the signal processing module. In the alternative or in addition, the control component and/or the control system can gradually check a sequence control of the process to the effect that a function, which is required in each step, is captured by the specified functional range.

The (preferably processed) electric signals from the processing component can be sent to the control system by means of the control component. In the alternative or in addition, the electric signals (which are to preferably be processed) can be received by the control system by means of the control component and can be guided to the processing component.

The control component can be configured to control and/or to regulate the at least one field device, for example according to an automation process. The control component can read out status information of the at least one field device and/or can send control signals to the at least one field device. The control component, for example the control module, can comprise a processor and a memory, which can be read by the processor, in which a control or user program is coded, during the execution of which the processor reads out the status information and/or sends control commands. In the alternative or in addition, the control component can be actuated and/or read out by a further control component (for example the external control component) and/or a control center (for example the control system). The control center can comprise a further control component, which can be configured for controlling and/or reading out the control component of the field control system. The read-out can comprise a read-out of the exchanged electric signals and/or of status information of the signal processing modules.

The control module can be configured to detect and/or to evaluate and/or to process the status information and/or to transmit it to the control system. In the alternative or in addition, the control module can send status information of the control module (for example an operating state and/or an error state of the control module) to the system control system.

The control component (for example the control module) can comprise at least one serial or parallel interface, which can be connected to the connecting module for exchanging the electric signals (for example the control signals and/or the status information). In the alternative or in addition, the control component (for example the control module) can comprise a serial or parallel interface, which is configured to receive the status information from the processing component and/or from the supply component. In the alternative or in addition, the control module can comprise a serial or parallel interface, which is configured to send the configuration to the connecting module.

In the alternative or in addition, the system connection can be a network connection.

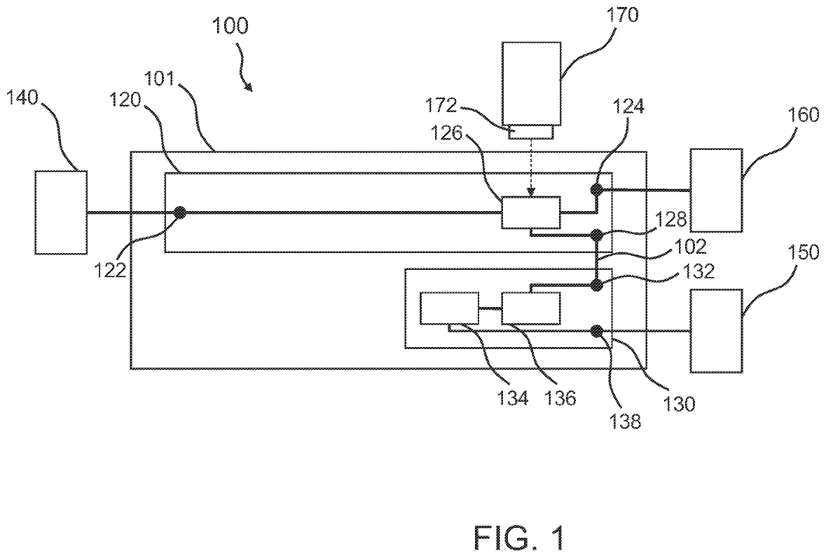

FIG. 1 shows a first exemplary embodiment of a field control system, which is generally identified with reference numeral 100. The field control system 100 comprises a control component 130, which is configured to exchange electric signals with a field device 140. The field control system 100 further comprises a processing component 120, which is configured to process the electric signals exchanged between the field device 140 and the control component 130. The processing component 120 and the control component 130 or can be mechanically and electrically connected thereby. In the connected state, the electric signals can preferably be exchanged between the field device 140 and a control system 150 by means of the processing component 120 and the control component 130.

The control component 130 is configured to control the field device 140 in accordance with the control system 150.

The processing component 120 and/or the control component 130 are preferably further configured to send and/or to receive status information bidirectionally.

The processing component 120 and the control component 130 each have a processing component connection 128 (for example a plug connector half) and a control component connection 132 (for example a plug connector half), which are configured to electrically and preferably mechanically connect the processing component 120 and the control component 130 to one another in the non-connected state.

The field control system 100 preferably comprises a housing 101, in which the control component 130 and the processing component 120 are arranged.

The housing 101 optionally has a control component bay, which is configured to receive the control component 130 and the processing component 120. The housing 101 further has a processing component bay, which is configured to receive the processing component 120. The housing 101 comprises a field control system interface 102, which is formed (or configured) to electrically connect the control component 130 and the processing component 120, preferably via the control component connection 128 and the processing component connection 132.

The processing component 120 comprises a field device connection 122, which is configured for the electro-conductive connection to the field device 140. The control component connection 128 of the processing component 120 is configured to establish the electrical connection to the control component 130 within the field control system 100. The processing component 120 preferably comprises an external control component connection 124, which is configured for the electro-conductive connection to an external control module 160, preferably a programmable logic controller (PLC), outside of the field control system 100. The processing component 120 is thereby configured for transmitting the electric signals between the at least one field device connection 122 and the control component connection 128 and/or the external control component connection 124.

The external control module 160 can comprise, for example, a programmable logic controller (PLC) and/or a control system, preferably a process control system (PCS, technically also: “Distributed Control System” or DCS). The control module 160 can be “external” in that sense that it is formed outside of the field control system 100.

The processing component 120 comprises a slot 126, which is configured to electrically and mechanically connect a signal processing module 170 to the processing component 120. The signal processing module 170 is thereby configured for processing the electric signals and/or for transmitting the electric signals between the field device connection 122 and the external control component connection 124. The slot 126 comprises, for example, a field-side portion, which is electro-conductively connected to the field device connection, and a control-side portion, which is electro-conductively connected to the control component connection 128. A plug connector half 172 on the signal processing module 170, which can be inserted into the slot 126, can therefore comprise a control-side and a field-side portion, which, in the inserted state, is electro-conductively connected to the control-side or field-side portion, respectively, of the slot 126.

The processing component 120 is further configured to provide status information of the processing component 120 (for example of the signal processing module 170) and/or of the field device 140 via the control component connection 128 and/or via the external control component connection 124.

The control component 130 controls the field device 140 (for example in accordance with the control system 150), in that the electric signals comprise control signals, which are sent to the field device 140. In the case of a regulation of the field device 140 by means of the control component 130, the electric signals can comprise feedbacks from the field device 140, for example actual values.

The control component 130 comprises the processing component connection 132, a control module 134 (for example a SPS), a configurable connecting module 136, and at least one system connection 138. The configurable connecting module 136 is thereby configured for the electro-conductive connection to the at least one processing component 120 by means of the processing component connection 132. The configurable connecting module 136 is preferably configured for the electro-conductive connection via the field control system interface 102.

The control module 134 can further be electro-conductively connected to the control system 150 via the at least one system connection 138, for example an ethernet connection and/or another industrial bus system. The electro-conductive connection can comprise one or several network switches (technically: switches) between the system connection 138 and the control system 150.

The configurable connecting module 136 has at least one connecting line, which is configured to be adapted (or configured) as a signal input and/or a signal output and/or which is configured to process (for example to detect and/or output) analog and/or digital electric signals.

The control module 134 is configured to detect status information of the field control system 100, wherein the status information is evaluated and processed by the control module 134 and/or is transmitted to the control system 150. Each component or each module of the field control system 100 can provide the status information.

The control component 130 can comprise a serial or parallel interface for exchanging the electric signals between the control module 134 and the configurable connecting module 136. The configuration of the configurable connecting module 136 is preferably determined or changed by the control module 134 via the serial or parallel interface.

The control module 134 can receive the status information (for example together with the electric signals or as the electric signals) via the serial or parallel interface. In the alternative or in addition, the control module 134 can comprise a further interface (for example a further electro-conductive serial or parallel interface or a radio interface), which is configured to receive the status information.

FIG. 1 further shows a first exemplary embodiment of the field control system 100, in the case of which the field control system 100 is formed from the housing 101. The housing 101 thereby comprises the control component bay, which electro-conductively connects the control component 130 to the field control system 100 and arranges it mechanically on the housing 101. The housing likewise comprises the processing component bay, which electro-conductively connects the processing component 120 to the field control system 100 and arranges it mechanically on the housing 101.

The first exemplary embodiment further shows that the field control system interface 102 is configured to electrically connect the control component 130 and the processing component 120 in the received state.

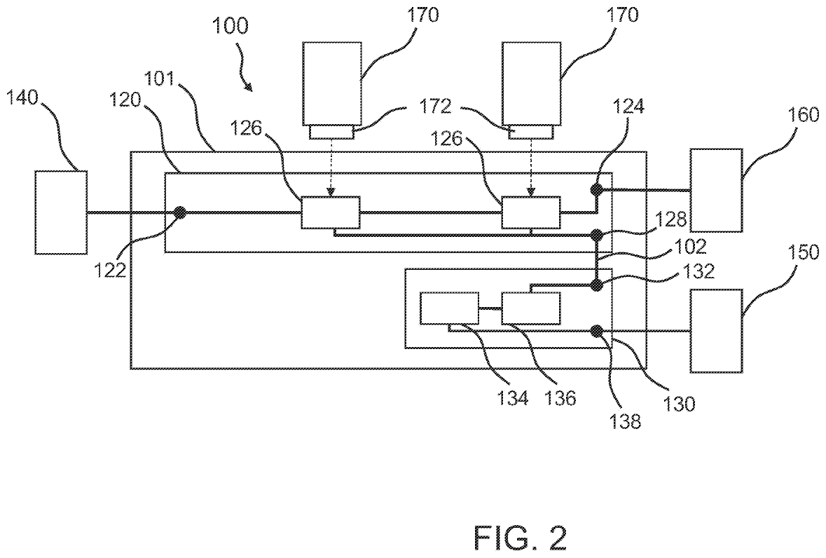

FIG. 2 shows a schematic block view of a second exemplary embodiment of the field control system 100. The second exemplary embodiment can be realized by itself or as further development of the first exemplary embodiment comprising several slots.

The processing component 120 comprises at least two slots 126, which are each configured to electrically and mechanically connect a signal processing module 170 to the processing component 120, for example insert it. Each of the connected signal processing modules 170 processes a portion of the electric signals and/or transmits the portion of the electric signals between the at least one field device connection 122 and the control component connection 128 and/or the external control component connection 124. Each signal processing module 170 is responsible, for example, for the electric signals of another channel to the at least one field device 140 or for the electric signals of another field device 140.

The slots 126 are preferably uniform. Each of the signal processing modules 170 can be inserted, for example, into one of the slots 126. Different slots 126 (for example the field-side portion thereof) can be electro-conductively connected to different field devices 140 via the field device connection 122.

According to its configuration, the connection module 136 can provide at least two UIO ports. The control-side portion of different slots 126 can be electro-conductively connected to different UIO ports of the connecting module 136, preferably via the control component connection 128.

In response to the status information of the different signal processing modules 170, the control module 134 changes the configuration of the respective UIO port of the connecting module 136 so that said port matches the function of the respective signal processing module 170 (for example with respect to the communication direction and/or signal form).

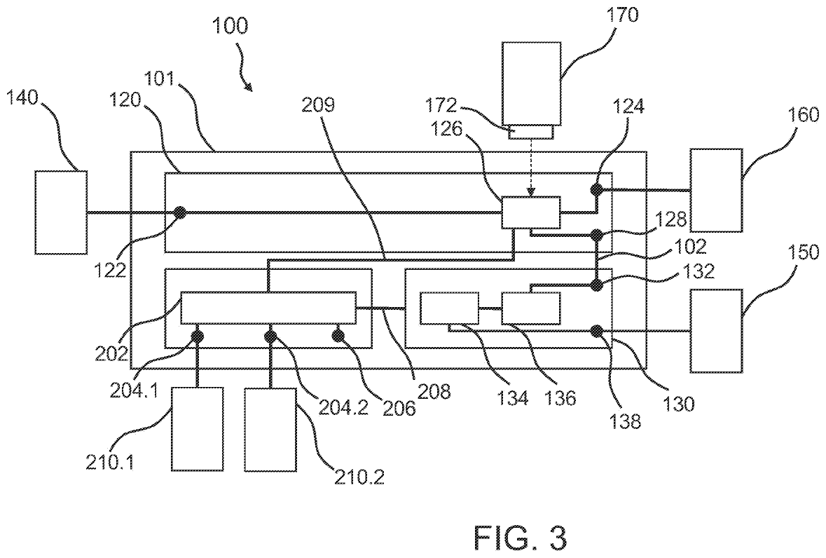

FIG. 3 shows a schematic block view of a third exemplary embodiment of the field control system 100. The third exemplary embodiment can be realized by itself or as further development or expansion of the first and/or second exemplary embodiment.

The third exemplary embodiment of the field control system 100 comprises a supply component 202. The housing 101 has, for example, a supply component bay, in which the supply component 202 is received or can be received.

The supply component 202 supplies the field control system 100 (preferably the processing component 120 and/or each slot 126) with electric energy. The supply component 202 can comprise an energy storage and/or can absorb the energy via an external supply connection 204. The supply component 202 can supply the electric energy to the control component 130 via a supply line 208 and/or to the processing component 120 via a supply line 209.

Reference numerals in the form of XYZ.1, XYZ.2, etc. can each be an exemplary embodiment of the feature XYZ.

The supply component 202 preferably comprises a first supply connection 204.1 and a second supply connection 204.2 for supplying a slot 126 of the processing component 120 and the control component 130 with the electric energy by means of the supply component 202. The supply component 202 is configured to optionally absorb the electric energy via the first supply connection 204.1 and/or via the second supply connection 204.2.

The supply component 202 is configured for providing status information of the supply component 202 to the field control system 100.

The supply component 202 optionally comprises a supply communication connection 206, which is configured to provide the status information outside of the field control system 100.

For example, the supply component 202 absorbs the electric energy at the first supply connection 204.1 via a or from a first energy supply 210.1. The second supply connection 204.2 further absorbs the electric energy via a or from a second energy supply 210.2. The supply component 202 preferably absorbs the electric energy from the first energy supply 210.1 and changes to the second energy supply 210.2 in the event of a failure of the first energy supply 210.1.

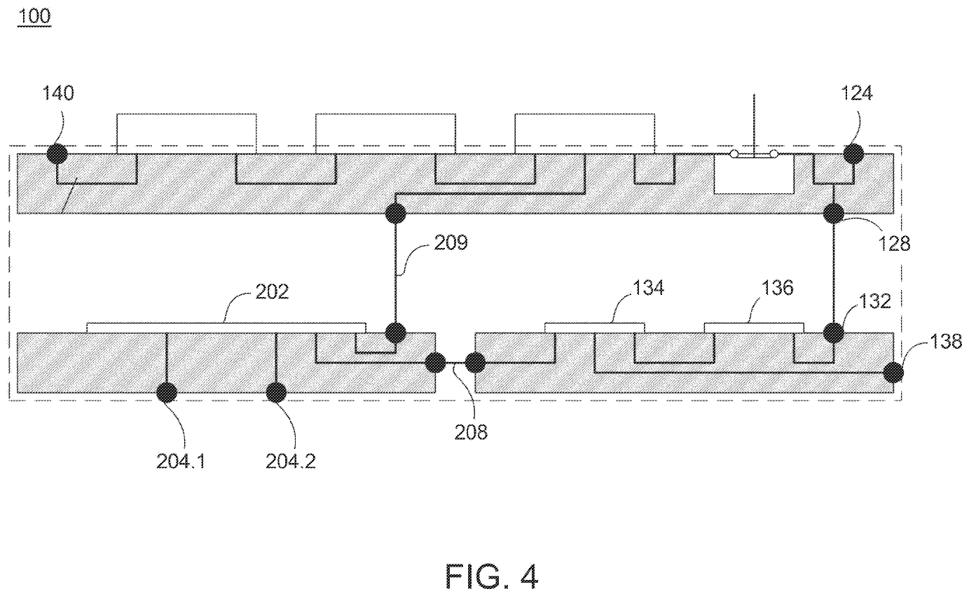

FIG. 4 shows a schematic sectional view of a fourth exemplary embodiment of the field control system 100, which can be realized by itself or as further development of any other exemplary embodiment. The field control system 100 can be designed modularly, for example by means of components 120 and 130, which are releasably connected by means of the connections 128 and 132. In the alternative or in addition, a sandwich construction of the printed circuit boards of the control component 130, of the processing component 120 and/or of a supply component 202 (for example with supply line 208 to the control component 130 and/or supply line 209 to the processing component 120) can be arranged or can be capable of being arranged in the housing 101.

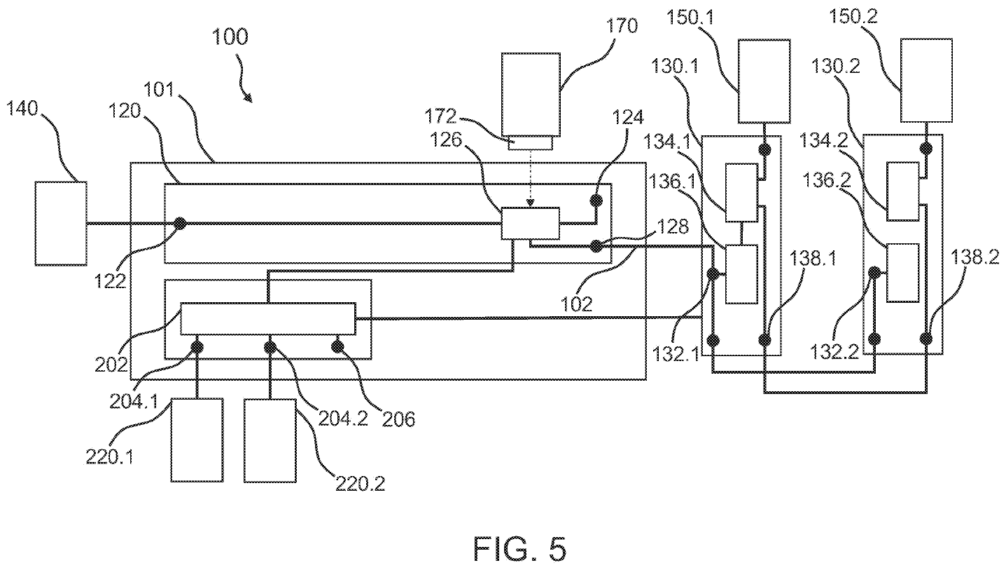

FIG. 5 further shows a fifth exemplary embodiment, which can be realized by itself or as further development of any other exemplary embodiment. In the fifth exemplary embodiment, the control component connection 128 of the field control system 100 is configured to electro-conductively and/or mechanically connect a first control component 130.1 and a second control component 130.2 to the field control system 100 (for example to the processing component 120 and preferably to the supply component 202). The first control component 130.1 and the second control component 130.2 is optionally arranged outside of the housing 101.

Each of the first control component 130.1 and of the second control component 130.2 can be an exemplary embodiment of the above-described control component 130, for example comprise at least one feature or all of the features of the control component 130.

The field control system interface 102 is formed, for example, to electro-conductively connect the first control component 130.1 and the second control component 130.2 to the processing component 120.

The first control component 130.1 is optionally connected to a first control system 150.1, and the second control component 130.2 is electro-conductively connected to a second control system 150.2.

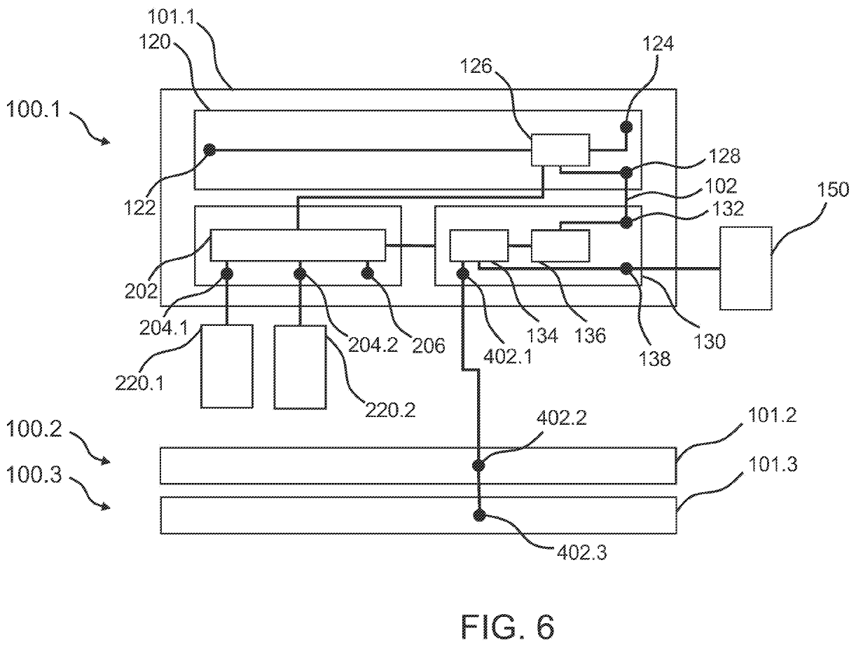

FIG. 6 schematically shows an application example of a first or of several field control systems 100, each comprising a connection to at least one further field control system 100. Each field control system 100 can be realized according to one of the exemplary embodiments, different exemplary embodiments of the field control system 100 can in particular be combined in the application example. For example, two, three (as will be described in an exemplary manner below), or more field control systems 100 are combined.

The control component 130 of a first field control system 100.1 has a field control system connection port 402.1, which is connected to a field control system connection port 402.2 of a second field control system 100.2 and a third field control system connection port 402.3 of a third field control system 100.3. The field control system connection port 402 can be a network connection, for example an ethernet connection.

The first field control system 100.1, the second field control system 100.2 and/or the third field control system 100.3 are formed according to one of the exemplary embodiments. The first field control system 100.1, the second field control system 100.2 and/or the third field control system 100.1 is further formed by means of the respective field control system connection port 402 to exchange the electric signals and/or electric control signals among one another or to pass them on.

The field control system 100 can provide a universal process bus 402 at the field control system connection port 402. In the alternative or in addition, the field control system 100 can always be installed or can be capable of being installed in a control cabinet (for example on a support rail) with the same housing 101, for example as uniform platform. The field control system 100 can be identified as net base.

The mentioned net base 100 can comprise active components, which comprise, for example, the control component 130 as bus coupler. These bus couplers 130 can form the interface between the control system 150 as a higher-level controller and the signal processing modules 170 (for example technically so-called “input/output accessory” or IOA). The bus coupler 130 can comprise universal or configurable connecting modules 136 comprising several I/O ports. This means that the corresponding I/O ports can be switched over between the signal forms DI, DO, AI, and AO. The number of the I/O ports can further be adapted by means of the subsequent adding of further net base 100.

The net base 100 can further comprise a voltage supply as supply component 202. In the alternative or in addition, the connections 402 and/or 138 can provide a connection to an industrial data bus, for example a coupling by means of wired ethernet, fiber optic, or radio technologies. Data can further be transmitted via the industrial data bus in order to construct, for example, a big data structure, so that field devices 100, for example plants, or entire process systems can be controlled more efficiently.

Process parameters can further be read out and processed accordingly by the control component 130, for example a PLC next controller, via the field control system interface 402 and/or the connections 132 and/or 128 and/or 102 and/or 124 as internal interface. The field control system interface 402 and/or the external control component connection 128 can make it possible for the plant operator to connect external control modules 160 to the net base 100 according to his safety concepts using a redundancy. This means that data of the field device 140 can be provided to external control modules 160 and/or to the control component 130 as the electric signal. The data can be further made available by a sensor system according to the use by means of a matching IOA 170.

To that effect, the net base 100 can lead to space savings, can lower installation efforts, can reduce the need for different components and/or can lower the service effort and the maintenance effort of the field control system compared to the prior art. A planning and installation phase of a process plant can further be reduced because the I/O ports provides a largest possible flexibility. The planning of the I/O ports can be conducted, for example, only shortly prior to the installation of the field control system 100. The adaptation to the corresponding field signals (i.e. the electric signals from the field device 140) can further be conducted during the start-up of the net base 100, wherein the adaptation can take place by means of a program of the control component 130, preferably a control or computer program, for example by means of a software. A shunting level known from the prior art can be forgone due to the configurability and/or due to the program.

If the use of redundancies is required, this can be realized with the use of different bays within the housing 101. Redundancies can further be conducted, for example by means of a software-side configuration. In the alternative or in addition, the housing 101 can have one or several universal (i.e. configurable) connecting modules 136.

The field control system 100 or the housing 101 thereof can also be referred to as basis element (or technically: “base element”). The base element 100 can be designed modularly, wherein the use of a respective one or several processing components 120, control components 130 and/or energy supply components 202 is made possible, preferably by means of corresponding bays.

In the alternative or in addition, the base element 100 can have one or several of the respective components. To that effect, the base element can provide a configuration, which is adapted to the application example of the base element 100. The base element 100 or the housing 101 can thereby have a uniform size and/or fastening points (for example for the support rail).

The modular design can further be conducted in a sandwich construction of the necessary printed circuit boards of the control component 130, of the processing component 120 and/or of the supply component 202. The housing 101 and/or the respective components can further have unique identifications, so that a separate use is made possible, for example one of the components and/or the housing 101 can be used separately. The unique identification can promote, for example, a separate distribution.

The field control system 100 can further have a redundant (preferably modular) voltage supply as supply component 202, which supplies the supply component 202 with electric energy via several supply connections 204. The several supply connections 204 can thereby be fed by different energy supplies 210 (for example voltage supplies).

The supply component 202 can ensure that different voltage supplies are evenly loaded. In the alternative or in addition, an overvoltage and undervoltage detection can be ensured by means of the supply component 202, and error messages can be output by the supply component 202 in response to overloading or unusual operating states, for example as the status information. These error messages can be transmitted as simple DO or a digital message as the status information via an interface 208, for example to the control component 130.

The interface 208 can be formed, for example, for the serial and/or parallel transmission and optionally for the electric supply, i.e. to supply the control component 130 with electric energy from the supply component 202 via the interface 208. The control component 130 can thereby detect a current status of the energy supply from the supply component 202. The status can provide, for example, messages via the connected energy supply 210, for example power supply units. For example, the presence of an energy supply 210 or of several energy supplies 210 and/or the function thereof can be specified. In the alternative or in addition, differences in the current consumption or temperatures of the energy supplies 210 or of a circuit of the supply component 202 can be provided as the status information.

During a normal operation, the supply voltages of the two voltage sources can be passed on to the corresponding IOAs 170 and/or to the field devices 140 via the supply line 209 and/or the slot 126.

The redundant voltage supply 202 can be available, for example, in two expansion phases. A first expansion phase can comprise, for example, the monitoring of the two energy supplies 210. In addition to the first expansion phase, a second expansion phase can likewise be able to register changes in the energy extraction. The start of the energy extraction can further be used to generate automated messages of the supply component 202 and/or of the control device 130, for example to the control system 150.

The use of the net base 100 can take place on the basis of existing technologies, whereby individual components 120 and/or 130 and/or 202 from the prior art can be further developed, for example in that the configurable I/O ports are integrated.

The electro-conductive connection for exchanging the electric signals (which can also be referred to as interconnection) can comprise different connecting methods. The control system 150 can thereby be electro-conductively connected directly, for example, to the control component 130. The control system 150 can further take over the control of the field control system 100 or of the control component 130, respectively, temporarily or partially.

The control system 150 can further communicate with the control component 130 on the basis of a real time bus (for example according to the architecture “OPC UA”). The OPC UA for “Open Platform Communications United Architecture” is a data exchange standard for the industrial communication, for example from field device 140 to control component 130 and/or from the control component 130 to the control system 150.

The control component 130 can further use an industrial data bus for communication purposes. The control system 150 can furthermore likewise have interfaces of an industrial data bus. The communication between the control component 130 and the control system 150 preferably takes place by means of the industrial data bus. The control system 150 can further communicate with the signal processing module 170 via the connecting module 136 of the control component 130, whereby the communication is preferably likewise conducted via an industrial data bus.

A redundant operation of a SAFETY application can further be made possible by means of the control component connection 124 and/or 128 and/or the processing component connection 132.

An interconnection of several net bases (as field control systems 100) can further be realized by means of an industrial data bus via the interface 402.

The field control system 100 can further be controlled by redundant external control modules 160. They can thereby be electro-conductively connected separately to the field control system 100 by means of the external control component connection 124. The housing 101 of the field control system 100 can further comprise an additional (i.e. further) control component 130 or can have no control component (for example when controlled by means of the control system 150).

The external control modules 160 can in each case be formed as a control component 130, wherein the external control modules, which are formed as control component, can optionally be configured for arrangement or mechanical connection in the control component bay of the housing 101. Each of the external control modules 160 can further be connected individually or redundantly to the base element 100.

The connection 124 between field control system 100 and the external control module 160 can comprise the mechanical connection and/or the electro-conductive connection (technically by means of “interfaces”).

For the connection of at least the processing component 120 to the control component 130, the housing 101 can comprise a system bus as field control system interface 102, whereby the system bus 120 can likewise preferably be used to connect the external control modules 160.

The system bus 102 can further meet safety requirements, which can comprise, for example, a requirement according to the standard IEC 61508 and/or the standard IEC 61511 (which may also be referred to as safety level or safety integrity level, technically “safety integrity level” or SIL), preferably up to SIL3. The safety requirement can thereby likewise comprise the firmware of the respective controllers.

A first or several first field control systems 100 can furthermore be interconnected to a second field control system 100 by means of the control component 130 as bus coupler via the field control system port 402. The field control system 100 can further be configured to be interconnected to a field control system 100 of a different type or of a different production, respectively, wherein the field control system 100 can access the functions, which are relevant for the field control system 100, or can control these relevant functions, respectively.

The bus coupler 130 of the first field control system 100 can, for example, control the control component 130 of another field control system 100, wherein the bus coupler 130 preferably provides for the communication between its field control system 100 and to the other (for example the subsequent) field control systems 100. The field control system 100 of the bus coupler 130 can thereby be referred to as master and/or the subsequent field control systems 100 can be referred to as so-called slaves.

The control components 130 of the slaves 100 can in each case further comprise a communication controller to the connection 402, which preferably provides for the coupling to the internal system bus 138 and/or the communication with the bus coupler 130 of the master 100. Several slaves 100 can be coupled to the corresponding bus coupler 130 by means of the system bus 402 and/or 138.

The communication controller can be a specific formation of the control component 130 or can be used instead of the control module 134, wherein the communication controller can preferably ensure the functionality to the IOAs 170 (for example the configurable IO ports). The communication controller can further be configured to adapt (or configure) the universal input and output channels (i.e. the configurable IO ports) of the connecting module 136 and/or to process the respective electric signals.

The system bus 402 and/or 138 can be formed as a redundantly designed communication bus, which ensures the communication between the bus coupler 130 of the maser 100 and the communication control systems of the slaves 100. This system bus (also: communication bus) can further meet safety requirements, such as, for example, SIL requirements, preferably up to SIL3. The safety requirement can thereby likewise comprise the firmware of the respective communication controllers.

The respective communication controller can further provide an additional serial communication at an industrial standard.

Exemplary embodiments of the field control system 100 (i.e. the net base) can in each case exist as so-called SAFETY alternative and Non-SAFETY alternative, for example be configured to be operated in an unsafe or in a safe environment, respectively. The SAFETY alternative can further comprise safety requirements, such as, for example, SIL requirements, preferably up to SIL3. The safety requirement can thereby likewise comprise the firmware of the respective field control system 100.

The electric signals (for example the status information) of the field control system 100 or of the field control systems 100 can further be provided to the control system 150 (for example a control center or a control system). This information can further be the basis for generating alarms in the control system. In the alternative or in addition, these messages and/or alarms can be given special priorities, so that the field system 100 and/or the control system 150 processes the electric signals within defined latency periods or cycle periods.

The base element 100, for example the slaves 100, can likewise provide electric signals (preferably status information, for example collected information or data, respectively) to the control system 150 by means of corresponding interfaces.

All of the available electric signals, preferably status information (field information, energy management, IOA data, etc.) can be accessed or sent, respectively, for example by the control system 150 or the control component 130. This information can further be exchanged by means of a cloud-based system (cloud system), which is connected, for example, to the internet and/or an intranet. This cloud system can further be configured to store, process, or analyze the information. The exchanged electric signals (preferably status information) can likewise be protected by means of corresponding safety mechanisms (for example an end-to-end encryption).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

| | |
|---|---|
| Field control system, also: net base | 100 |
| or base element | |
| Housing of the field control system | 101 |
| Field control system interface of | 102 |
| the field control system | |
| Processing component | 120 |
| Field device connection of the | 122 |
| processing component | |
| External control component connection | 124 |
| of the processing component | |
| Slot for signal processing module | 126 |
| Electrical and/or mechanical connection | 128 |
| to the control component, preferably | |
| control component connection, for | |
| example plug connector half | |
| Control component, also: bus coupler | 130 |
| Electrical and/or mechanical connection | 132 |
| to the processing component, preferably | |
| processing component connection, for | |
| example plug connector half | |
| Control module of the control component | 134 |
| Connecting module of the control component | 136 |
| System connection of the control component | 138 |
| Field device | 140 |
| Control system | 150 |
| External control module | 160 |
| Signal processing module, also: | 170 |
| “input/output accessory” or IOA | |
| Plug connector half of the signal | 172 |
| processing module | |
| Supply component, preferably voltage supply | 202 |
| Supply connection of the supply component | 204 |
| Supply communication connection | 206 |
| Supply line and/or data line to the | 208 |
| control component | |
| Supply line to the processing component | 209 |
| Energy supply | 210 |
| Field control system connection port | 402 |

1. A field control system, comprising:
a control component configured to exchange electric signals with at least one field device; and
a processing component configured to process electric signals exchanged between the at least one field device and the control component,
wherein the processing component and the control component are electro-conductively and mechanically connected or connectable, and
wherein, in a connected state, the electric signals are exchangeable between the at least one field device and a control system connected to the field control system by the processing component and the control component.

2. The field control system of claim 1, wherein the processing component and the control component are connected by a common housing and/or irreversibly mechanically.

3. The field control system of claim 1, wherein the control component is configured to control or regulate the at least one field device.

4. The field control system of claim 1, wherein, in the connected state, the processing component and the control component are configured to transmit status information of the processing component to the control component.

5. The field control system of claim 1, wherein the processing component and the control component comprise a control component connection and a processing component connection, respectively, which are configured to electro-conductively connect the processing component and the control component to one another in the connected state.

6. The field control system of claim 1, further comprising:
a housing configured to mechanically connect the control component and the processing component by a control component bay, which is configured to receive the control component, and a processing component bay, which is configured to receive the processing component; and
a field control system interface configured to electro-conductively connect the control component and the processing component to one another in the connected state.

7. The field control system of claim 1, further comprising:
a supply component configured to supply the control component and/or the processing component and/or the field control system with electric energy,
wherein the supply component comprises at least one supply connection configured to receive electric energy for supplying a slot of the processing component and/or for supplying the control component.

8. The field control system of claim 7, wherein the supply component has two or more supply connections, and
wherein the supply component is configured to receive electric energy selectively from a first supply connection of the two or more supply connections and from a second supply connection of the two or more supply connections.

9. The field control system of claim 7, wherein the supply component is configured to transmit status information of the supply component to the field control system.

10. A processing component for forming the field control system of claim 1 and for processing electric signals exchanged between the at least one field device and the control component, the processing component comprising:
at least one field device connection configured for electro-conductive connection to the at least one field device outside of the field control system; and
a control component connection configured for the electro-conductive connection to the control component within the field control system,
wherein the processing component is configured to process the electric signals exchanged between the at least one field device connection and the control component connection.

11. The processing component of claim 10, further comprising:
an external control component connection configured for the electro-conductive connection to an external control module outside of the field control system,
wherein the processing component is configured to process electric signals exchanged between the at least one field device connection and the external control component connection.

12. The processing component of claim 10, further comprising:
at least one slot, which is in each case configured to electro-conductively and mechanically connect a signal processing modulo to the processing component; and
at least one signal processing module insertable be inserted into the at least one slot, the at least one signal processing module being configured to process electric signals exchanged between the at least one field device connection and the control component connection and/or the external control component connection.

13. The processing component of claim 10, wherein the processing component is configured to provide status information of the processing component, at the control component connection and/or at the external control component connection.

14. A control component for forming the field control system of claim 1, the control component comprising:
a control module configured to exchange electric signals with the at least one field device;
at least one configurable connecting module and a processing component connection, which are configured to electro-conductively connect the control module to the processing component for exchanging the electric signals via the configurable connecting module; and
at least one system connection, via which the control module is electro-conductively connected or connectable to a control system,
wherein, in the connected state, the electric signals are exchangeable with the control system.

15. The control component of claim 14, wherein the processing component connection is configured to mechanically connect the control component to the processing component.

16. The control component of claim 14 or 15, wherein the control module is configured to control the at least one field device.

17. The control component of claim 14, wherein the at least one configurable connecting module in accordance with a configuration of the configurable connecting module is configured to:
on at least one connecting line of the processing component connection,
selectively acquire or output the electric signals and/or
process selectively analog or digital electric signals.

18. The control component of claim 14, wherein the control module is configured to acquire status information of the processing component and/or to transmit status information of the processing component to the control system by the system connection.

19. The control component of claim 17, wherein the control module is configured to change a configuration of the configurable connecting module in response to the acquired status information of the processing component.

20. The field control system of claim 3, wherein the control component is configured to control or regulate the at least one field device in accordance with the control system.
